(19) United States
(12) Patent Application Publication
(10) Pub. No.: US 2016/0186566 A1
(43) Pub. Date: Jun. 30, 2016

(54) APPARATUS, SYSTEM AND METHOD FOR MATERIAL EXTRACTION IN UNDERGROUND HARD ROCK MINING

(71) Applicant: Fred STANFORD, Toronto (CA)

(72) Inventor: Fred STANFORD, Toronto (CA)

(21) Appl. No.: 14/911,500

(22) PCT Filed: Aug. 12, 2014
(86) PCT No.: PCT/CA2014/000616

§ 371 Date: Feb. 11, 2016

Related U.S. Application Data
(60) Provisional application No. 61/865,043, filed on Aug. 12, 2013.

(51) Int. Cl. E21F 13/00; E21D 9/12; B65G 67/24; B65G 15/00; B65G 67/10

(52) U.S. Cl. CPC E21F 13/00; B65G 15/00; B65G 67/10; B65G 67/24; E21D 9/126

(57) ABSTRACT

A method of extracting materials from an underground mine comprises positioning a flexible conveyor train in a materials loading zone. The conveyor train may be loaded by, concurrently or intermittently, loading materials onto a loading end of the conveyor and activating the conveyor to move the materials downstream along the conveyor. The conveyor is deactivated when loaded and the conveyor train then transports the loaded conveyor to a materials unloading zone for unloading.

### FIELD OF THE INVENTION

This invention relates to the field of mining. In particular, the invention relates to an apparatus, system and method for underground hard rock mining.

### BACKGROUND OF THE INVENTION

Ore extraction from an underground hard rock mine is primarily a materials handling operation, which is capital- and labor-intensive.

The economics of an underground mine is a function of multiple variables including, for example, the grade of the ore (concentration of pay metals in the rock), processing recovery rates (the percentage of pay metals that can be extracted from the rock), commodity prices (prices that can be received for the pay metals), capital investment per unit of pay metal, the length of time between the capital investment and ore production to provide the revenue stream needed to recoup the investment, operating cost to extract each tonne of ore (primarily the cost per tonne for labor, energy, supplies, etc.), and financing costs and taxation. There is little that a mining company can do to influence grade, commodity prices, financing costs, or taxation, given that the markets control commodity pricing and financing costs, nature controls the grade of the ore, and governments control taxation rates.

However, the remaining variables offer significant opportunities to maximize economic returns. For example, a mining company can greatly improve the economics of a mine by reducing capital intensity (for example, reducing the capital investment per unit of pay metal and reducing the length of time between the capital investment and the production of revenues from the investment), reducing operating costs, and increasing metal recovery rates from processed ore.

In an underground mine 10, the passageways 12 through which personnel, equipment and material are moved are called “drifts” if they are substantially horizontal, “ramps” if they are inclined, or “shafts” if they are vertical. Creating these passageways 10 is achieved through a primary mining process called “development,” which at greater than $5,000 per meter can be extremely expensive. The creation of these passageways 12 is also time consuming. For example, in a typical case a passageway may progress by approximately four meters per day, and most underground mines require many kilometers of passageways. For most mines the development process continues until nearly the end of the life of the mine, since as the ore in one area is depleted a new area needs to be accessed in order to provide for the future production of ore. Reducing the cost and time required to develop a mine is an important factor in minimizing capital intensity.

Once the passageways 12 are created, there is a construction process in which the services and equipment necessary to support the future production material handling activities are installed. Construction underground is difficult, expensive and time consuming. Any process redesign that can minimize the requirement for or amount of underground construction will have a significant impact on costs. Where construction cannot be avoided, substantial valuable time can be saved if the construction process can be done concurrently with the development process. Only once the construction process is completed can the production process start, with associated revenues to recoup the capital investment and generate a return.

Given that mining is primarily a material handling exercise, the largest opportunities for cost savings lie in redesigning the material handling processes that drive most of the cost, which are the processes that move ore and waste rock (also referred to herein as “muck” 2), supplies and waste, and workers. While there have been many incremental changes to the existing processes involved in the underground transport of workers, supplies, and ore/waste rock, such changes have largely involved changing similar processes to be larger in scope, faster, or more automated.

The material handling processes used today are primarily centered around ore and waste rock removal using diesel powered, rubber-tired vehicles 14, as shown in FIG. 3. In conventional mining operations various forms of truck and front-end loaders figure heavily in the design of the material handling systems, particularly those that move ore and waste rock. The process of moving ore essentially involves loading the ore onto a vehicle, hauling it to a materials unloading zone, and then dumping it. To increase productivity, it became apparent that the trucks 14 needed to be made, larger to carry more muck 2 per trip, and the speed of the trucks through the drifts and ramps had to be increased in order to reduce the muck 2 transport cycle time.

Over time, however, some significant negative unintended consequences to cost and scheduling resulted from increasing the size and speed of the trucks used for hauling ore and waste rock. Trucks by their very nature are short and wide. To increase their size, the trucks can be made a bit longer, but then they become difficult to dump. Accordingly, the size of the trucks has been increased by making them wider and higher, which requires larger drifts and ramps so that the trucks can safely traverse the passageways 12. If the truck is to go faster, the drifts and ramps need to be made even wider, particularly at corners, to avoid collisions with the walls of the mine 10. The additional time and money required to excavate these larger drifts and ramps became a significant drag on the economic returns on a project.

The size of the drifts and ramps has a significant direct impact on the cost of the mine per unit ore produced. Larger drifts produce much more waste rock that needs to be removed, which is expensive and can displace ore that tends to be handled by the same systems. Also, ground support in a large drift is much more complex and expensive than in a small drift. From a labour perspective, it takes much longer to complete all of the daily tasks associated with excavating a larger drift as opposed to a smaller one. This has resulted in a significant reduction in the linear advance rates in developing the drifts to access ore deposits which, in turn, has extended the time between the deployment of capital and the production of revenues from the mine Extending this time period has a negative effect on the Net Present Value (NPV) of the mine.

Furthermore, more equipment is required to create and service larger drifts, and the equipment tends to be larger, more complex, and more expensive. Equipment that is larger and more varied requires larger and more complicated repair facilities. It also requires more training for maintenance personnel and increased parts warehousing, and utilizes more fuel. Thus, in underground hard rock mining, increased complexity has commensurate negative cost and operational reliability consequences.

While the impacts described above are all significant, one of the most significant unintended consequence has been to ventilation systems used in an underground mine 10. A truck 14 that is moving along a drift emits exhaust. The drift is a contained environment, so the exhaust needs to be flushed away by pumped-in ventilating air. If the air moves through the drift at the same speed as the truck then the truck will in effect continue to pollute the same air, which would be unsafe. To avoid this possibility, air has to be moved through the drift faster than the truck. The large cross-sectional areas in big drifts means that the volume of air required to get the required rate of air flow from the mine is incredibly high. Hundreds of millions of dollars are spent on upgrading ventilation systems in mines in order to allow short and wide trucks to get wider and higher, and to go faster.

There are thus many advantages to keeping the drifts and ramps as small as possible, but the use of trucks to haul ore and waste rock necessitates a minimum drift size. Trucks are a “batch” material handling system. In a batch system it is more productive to take a bigger load per trip and to increase transport speed in order to reduce the cycle time of each trip, which will by definition move more material in any given time period. Success in moving more material per trip and more trips per hour largely spreads the fixed costs of the operation over a greater amount of product, with the net effect of reducing the unit cost of the product. However, the “short and wide” truck material handling solution that the mining industry has pursued has had the unintended consequence of driving up fixed costs, which has negated many or most of the benefits of moving more material per batch and increasing the number of batches moved each day.

There is accordingly a need for a more efficient ore and waste rock removal system for use in underground hard rock mining applications.

### BRIEF DESCRIPTION OF THE DRAWINGS

In drawings which illustrate one or more embodiments by way of example only,

FIG. 1 is a schematic diagram illustrating a prior art underground hard rock mine.

FIG. 2 is a schematic diagram illustrating a mine shaft in a prior art underground hard rock mine.

FIG. 3 is a schematic diagram illustrating the movement of rubber-tired vehicles in a conventional ore extraction technique.

FIG. 4 is a schematic elevation of the drift in the mine of FIG. 3.

FIG. 5 is flowchart illustrating an example of the development process for underground hard rock mining according to one or more embodiments described herein.

FIG. 6 is a schematic diagram illustrating an ore extraction system according to the present invention.

FIG. 7 is a schematic elevation of the drift in the mine of FIG. 6.

FIG. 8 is a schematic perspective view of an embodiment of a conveyor train according to the present invention.

FIG. 9 is an end elevation of a section of the conveyor train of FIG. 8 mounted on ground rails in a drift.

FIG. 10 is an end elevation showing a track sized for the conveyor train of FIG. 8 and providing an intermediate rail for accommodating a standard rail car on the same track.

FIG. 11 is a side elevation of the conveyor train of FIG. 8 mounted on a roof rail in a drift.

FIG. 12 is a top plan view showing the movement of end-loaded muck 2 along the conveyor train conveyor.

FIG. 13 is a plan view showing a two-track layout in a system of the present invention.

FIG. 14 is a plan view showing a single-track layout in a system of the present invention.

FIG. 15 is an end elevation of a conveyor train according to the invention mounted on a roof rail in a drift.

FIG. 16 is a partial side elevation of a portion of the conveyor train of FIG. 15.

### DETAILED DESCRIPTION OF THE INVENTION

The present invention relates to the application and use of a mobile materials conveyor in a system for an underground hard rock mine, and a method of mining utilizing a mobile materials conveyor. Because of the reduced cost of underground mining utilizing the apparatus, system and method of the invention, some mines which would otherwise be mined by “open pit” mining methods can be mined by underground mining Open pit mining is typically less expensive than underground mining, but is far more destructive to the environment because it requires the unnecessary removal of surface materials for the sole purpose of accessing the ore underneath the surface. The invention is thus advantageous not only from a cost perspective, but also in terms of its significantly lesser environmental impact in comparison to open pit mining.

The invention thus provides a method of extracting materials from an underground mine, comprising the steps of a. positioning a conveyor train in a materials loading zone; b. loading a conveyor train conveyor by, concurrently or intermittently, b.1 loading materials onto an upstream end of the conveyor train conveyor, and b.2 activating the conveyor train conveyor to move the materials downstream along the conveyor train conveyor; c. driving the conveyor train to a materials unloading zone; and d. unloading the conveyor train conveyor.

The invention further provides a system for extracting materials from an underground mine, comprising a conveyor train for moving the materials between a materials loading zone and a materials unloading zone, the conveyor train being supported on at least one rail and comprising a conveyor train conveyor, and a loading apparatus for loading materials onto an upstream end of the conveyor train conveyor when the conveyor train is stationary, whereby when the conveyor train conveyor is loaded the conveyor train can be repositioned to a materials unloading zone and the conveyor train conveyor can be activated to unload the conveyor at the materials unloading zone.

The specific examples described herein are given by way of illustration only. It will be appreciated that not all advantages apply to all embodiments.

There is no way to control where the ore is deposited underground, so accessing and removing ore almost inevitably involves changes in direction in both the horizontal and vertical planes. An effective and efficient hard rock mining system needs to be able to negotiate corners and traverse steep grades. This is why rubber-tired trucks are commonly used in conventional underground mining techniques.

Conventional trains can go around corners, but have very little traction and therefore a limited ability to climb steep ramps. Conventional trains can only climb grades of less than about 25% of what is often needed in mines. Furthermore, the primary removal equipment needs to be able to get very close to the face of the mine, and since the face keeps moving forward as the mine is developed this equipment needs to move fairly often, so the implementation of a train for removing ore and waste rock from the mine does not obviate the need for rubber-tired equipment and/or crawler-mounted equipment at the working “face” where the ore or waste rock is first retrieved. Moving rubber-tired equipment through a drift that has a rail system installed on the floor can be difficult and very hard on both the tires of the primary ore removal vehicles and the railbed. If there is not enough room for the vehicles to avoid the rails the drift must be widened, resulting in the problems discussed above.

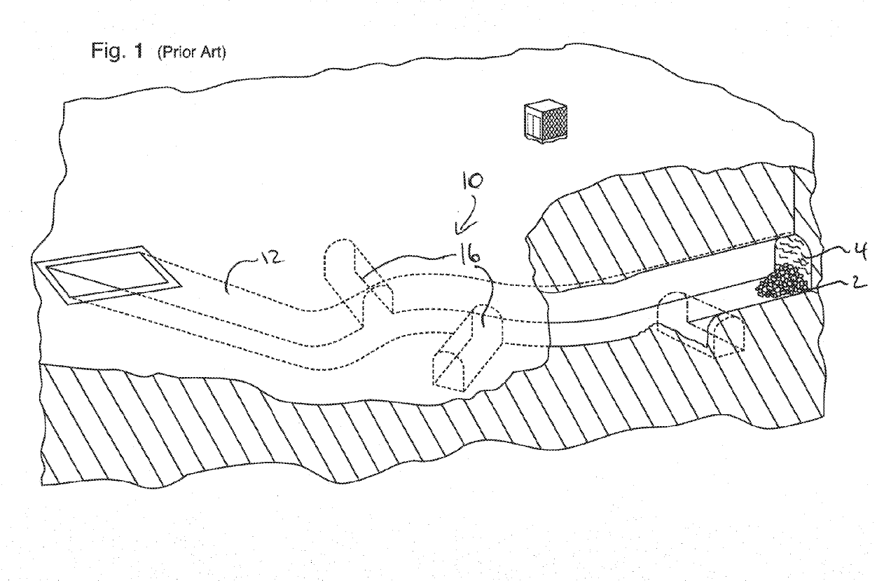

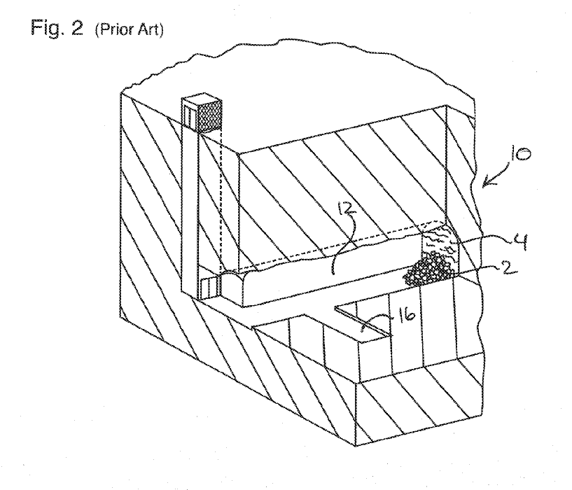

Also, to load a train by dumping ore and waste rock from primary muck 2 removal vehicles requires both additional width in the drift so that the tired vehicles can move alongside the train in order to load it to capacity and turnaround bays 16, for example as illustrated in FIGS. 1-3. The creation of turnaround bays 16 as the mine progresses is yet another recurring cost to be added to the overall cost of the mine.

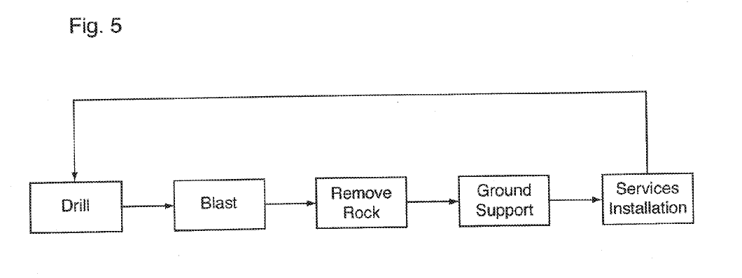

FIG. 5 illustrates an example development process for underground hard rock mining according to one or more embodiments described herein. For example, the development process may be used in the development of drifts, ramps, etc. throughout the mining operation. In some embodiments the development process include drilling, loading explosives, blasting, removing rock (or “muck 2”), establishing ground support, and services installation. Once services have been installed the development process returns to the drilling step and repeats to excavate the next few meters of the drift.

According to the invention, an end-loading conveyor train 30 is provided to receive muck from the mine face 4 and transport the muck 2 to a materials unloading zone outside of the mine 10. As compared to conventional truck haulage techniques, the use of the end-loading conveyor train 30 described herein results in improved efficiencies in the removal of rock and ore and can operate in smaller passageways 12, thereby reducing the need for complex underground engineering and significantly reducing the cost of utilizing an underground mining technique.

For example, implementing an end-loading apparatus such as the conveyor train 30 described herein in the context of underground hard rock mining obviates the need for a loading vehicle 18 to move into position beside the conveyor train 30 in order to load muck 2 for transport out of the mine, which allows for significant reduction in the size of the passageways 12, with the associated reduction in cost and time to create them. For example, a reduction of tunnel size from 5 m×5 m (25 m²) to 4 m×4 m (16 m²) results in over 36% reduction in the cross-sectional area of passageways 12, with commensurate cost and scheduling benefits. Instead a dual-function loader 19 comprising a shovel 19a at one end and a conveyor belt 19b at the other end, for example (without limitation) a “Haggloader” (trademark) mucking crawler manufactured by Atlas Copco, can be used to end-load the conveyor train 30.

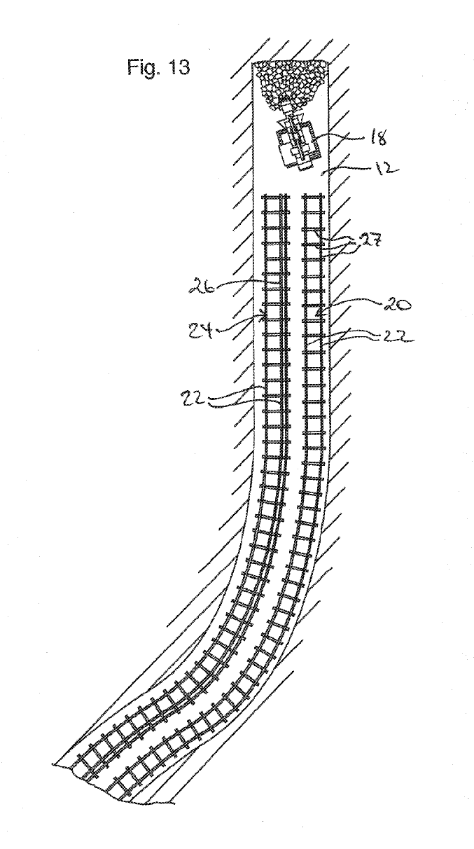

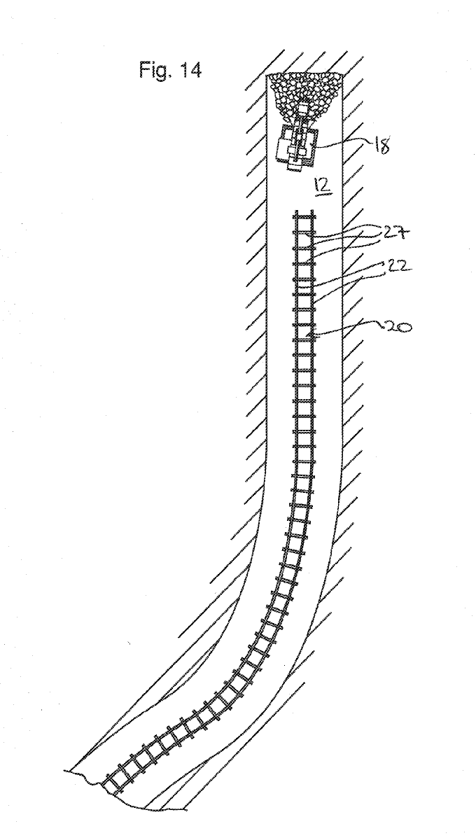

The system and method of the invention can operate utilizing a single track 20 comprising narrow-gauge rails 22, as illustrated in FIG. 14, constructed and secured to the floor of the passageway 12 in a conventional manner. Alternatively, dual tracks 20, 24 can be used to allow for simultaneous inbound and outbound traffic, as in the embodiment illustrated in FIG. 13.

If desired, an extra rail 26 can be added to the track, as in track 24 illustrated in FIG. 13, outside of the narrow-gauge rails 22, to provide access through a passageway 12 to standard-gauge rail vehicles such as passenger or cargo rail cars (not shown), to move personnel and equipment to and from the mine face 4. For example, personnel movement can be effected on the standard gauge rail pair 22, 26 in ‘street legal’ trucks equipped with Hi-Rail adaptors. Supply movement can also be containerized, automated and handled on the standard gauge rail pair 22, 26, for example with mining equipment moved on flatcars, obviating the need to have rubber-tired equipment driving on or beside the rails. The net result is a system providing reduced capital cost, which moves more material per hour and more material per unit of labour and energy.

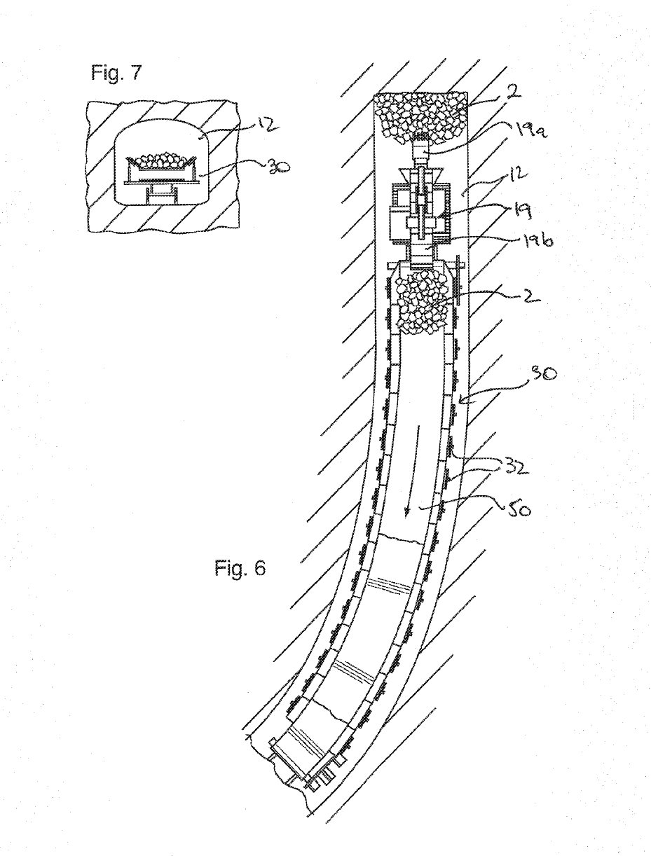

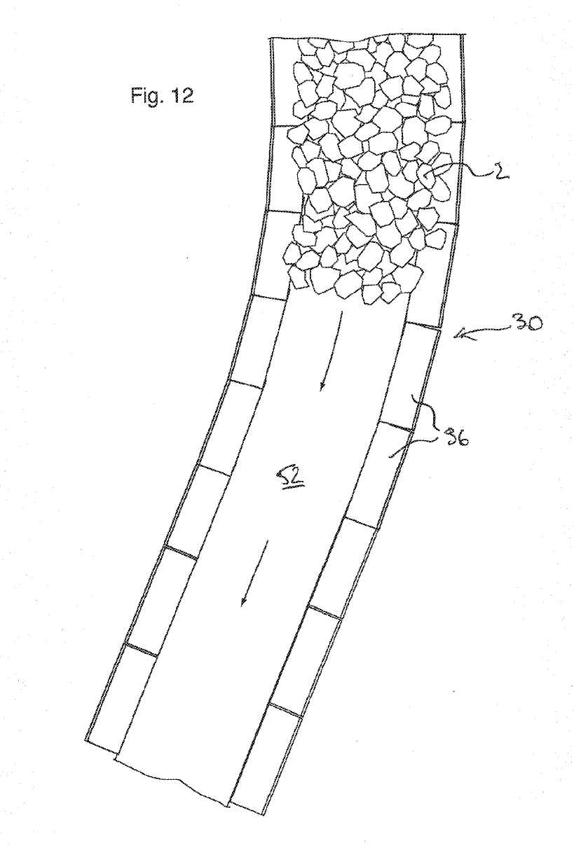

A first embodiment of a conveyor train 30 used in the system of the invention is illustrated in FIGS. 6-12. A suitable conveyor train 30 for the system of the invention, by way of non-limiting example only, is the flexible conveyor train system manufactured by Joy Mining Machinery, which is segmented so as to allow the conveyor train to negotiate 50 m radius corners in a mine.

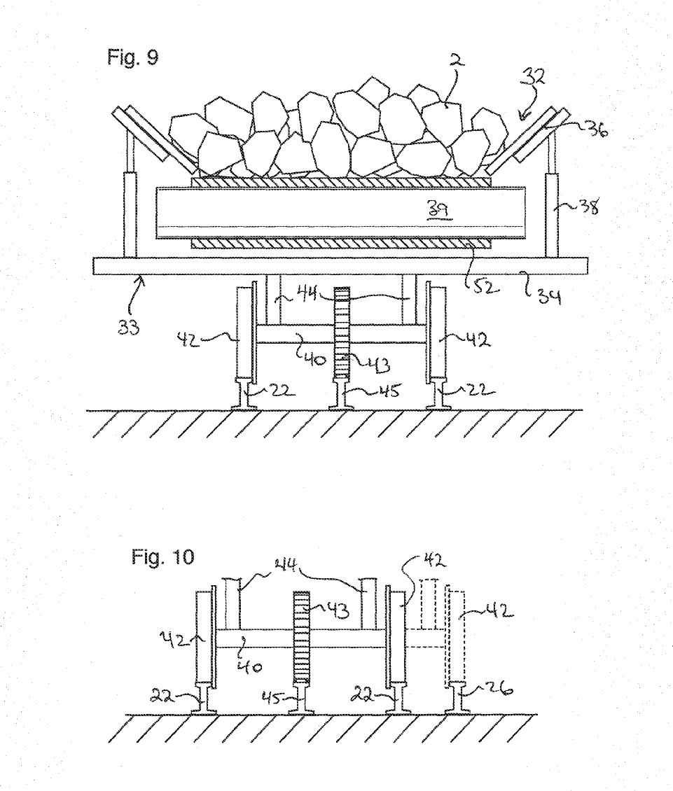

In the embodiment illustrated the conveyor train 30 comprises a plurality of segments 32 each supported by a frame 33. As best illustrated in FIG. 9, each segment frame 33 comprises a platform 34 providing a pair of vertical supports 38 on each side of the frame 33. Each pair of vertical supports 38 in turn supports troughing idlers, each for example comprising a side panel 36 preferably disposed at an angle converging toward the conveyor 50 so as to provide a ‘trough’ shape in cross-section, as best seen in FIG. 9, with the upper portion of the conveyor belt 52 as the floor of the ‘trough’. The frame 33 of each segment 32 is in turn mounted on wheels 42, each supported on an axle 40 sized for the track 20 comprising a narrow gauge pair of rails 22. The series of railway axles 40 provide a wheelbase complementary to the pair of rails 22, and may be connected by drawbars, all of which support the conveyor 50. The conveyor train 30 may be constructed and operated in the manner described in U.S. Pat. No. 6,651,804 issued Nov. 25, 2003 to Joy MM Delaware, Inc., which is incorporated herein by reference in its entirety. The conveyor train 30 may be equipped to carry upwards of fifty tonnes on the conveyor belt 52 and the conveyor belt 52 may be configured to be stationary on the train while the conveyor train is in motion.

In this embodiment the conveyor train is preferably driven by a ‘rack and pinion’ drive comprising 43 meshing with a toothed rail 45 mounted to the floor of the drift in the same fashion as the rails 22, shown in FIGS. 9 and 10. The cogwheel 43 is rotationally fixed to the axle 40. At least one segment 32 of the conveyor train 30 is provided with a motor (not shown), for example an electric motor mounted beneath the frame 33 and geared to the axle 40, for rotating the axle 40. This in turn rotates the cogwheel 43 to advance the segment 32, and thus the entire conveyor train 30, along the rails 22. In the preferred embodiment a plurality of segments 32 are each provided with a motor, reducing the power required for each motor since the driving force is thereby divided amongst a plurality of segments 32.

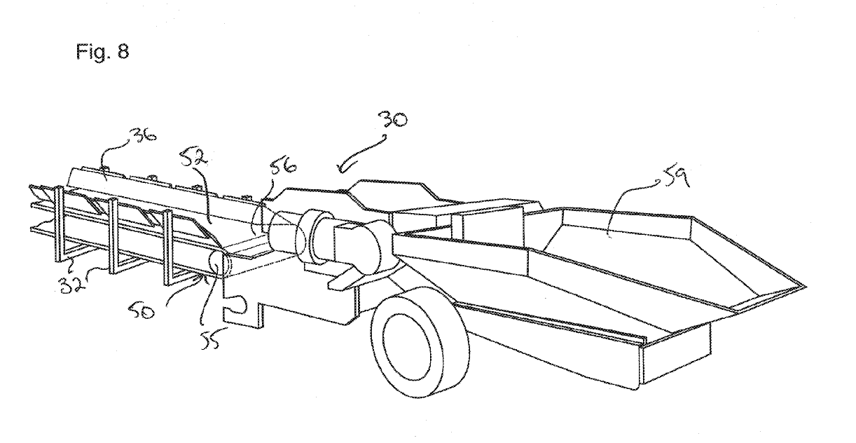

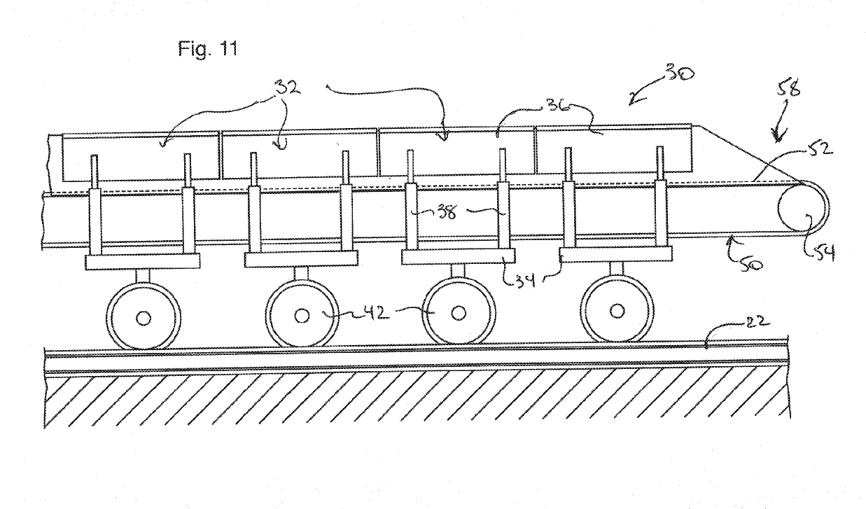

The segments 32 each support a conveyor 50 extending substantially along the length of the conveyor train 30. The conveyor 50 comprises a conveyor belt 52 driven by motorized rollers 54, the conveyor belt 52 being constructed and supported in the manner described in U.S. Pat. No. 6,651,804 so as to provide a continuous conveyor 50 having a loading end 56 at one end of the conveyor train 30 (seen in FIG. 8) and an unloading end 58 at the other end of the conveyor train 30 (seen in FIG. 11).

In the preferred embodiments a rack-and-pinion drive system allows the conveyor train 30 to traverse the steep gradients that are common in underground hard rock mines 10. In the floor-mounted embodiment illustrated in FIGS. 6-12, the rail system is designed to operate in a manner similar to conventional train operation in portions of a mine that are relatively flat, and as a rack-and-pinion (cogwheel) railway system in portions of the mine with steeper inclines. The embodiment illustrated in FIGS. 9-11 provides a cogwheel as part of the wheels 42 for each segment 32 of the conveyor train 30. In alternate embodiments a separate cogwheel may be provided along the axle 40, of each segment 32 or one or more selected segments 32, and a complementary rack affixed to the railway ties 27 to create a rack and pinion drive system similar to that of a conventional cogwheel train.

In the embodiment of the track illustrated in FIG. 13, one or more conveyor trains 30 may be positioned to operate along the dual tracks 20 such that multiple development activities can occur simultaneously throughout the mine 10. The dual-track embodiments allow for high-volume transport of ore, supplies, and other materials, with one track servicing inbound traffic and the other track servicing outbound traffic. This reduces development time in comparison to conventional approaches to hard rock mining, in which the short and wide equipment permits only one development activity to take place at a time. A dual-track rail system according to embodiments of the present invention thus allows for multiple development activities to take place simultaneously. For example, development waste may be extracted on one track 20 while second-pass ground support or service installation is taking place on the other track 20 simultaneously.

The conveyor train is designed to be long enough to carry the desired payload on the conveyor. For example, the length of the train could be approximately 130 meters; however, the length will vary with the desired payload and density of the ore. A long and skinny train (e.g., 130 m long by 1 m wide) allows for bi-directional traffic in a four meter (4 m) wide drift, as illustrated in FIG. 6B.

In this embodiment the conveyor train thus comprises a series of joined segments 32 supporting a conveyor 50 traversing substantially the length of the conveyor train 30. This allows the conveyor belt 52 to operate when the train 30 is parked around a corner, and also allows a loaded conveyor train 30 to negotiate corners in the mine 10. In some embodiments of the conveyor train 30, the bulk of the train could be a series of single axle “trailer” cars that are connected together (e.g., similar to a wagon) with a double-axle head-end and tail-end. The drive system, for example a cogwheel drive meshing with a rack as described above, could be integrated into the head-end and tail-end arrangements, or could be a separate unit that attaches to the head end or tail end of the conveyor train 30. Drawbars (not shown) that connect the axles 40 together could be connected together with “U” joints to allow for vertical and sideways flex for cresting hills and cornering. As compared with a traditional train coupler, the “U” joint will limit minor variations in the length of the train 30, which will aid in the operation of the conveyor. The frames 33 that support the conveyor 50 would be supported on the drawbars. In such an embodiment, beams with troughing idlers on top and attached to a single axle 40 may together make up a rail car of the conveyor train 30.

A shovel head 59 may be provided at one end of the conveyor train 30 to collect muck 2, as in the embodiment of a conveyor train 30 illustrated in FIG. 8. However, in the preferred embodiment the discharge conveyor 19b of the dual-function loader 19 is disposed directly over the end of the conveyor 50, initially with an overlap so that muck 2 is deposited onto the conveyor 50 a short distance from the end of the conveyor train 30 and as the dual-function loader 19 excavates the muck 2 and moves forward to the face it is still depositing muck onto the conveyor, as shown in FIG. 6. As part of the services installation the tracks are extended so as to be an appropriate distance from the face 4 after the next blast. This allows for continuous removal of muck 2 from the face when muck 2 is available to be moved and later on in the development cycle services can be installed concurrently while ground support and drilling activities are taking place at the face 4, thereby speeding up the development process.

According to the system of the invention, the conveyor 50 is deactivated and therefore stationary on top of the conveyor train 30 when the conveyor train 30 is in transit between the materials loading zone and the materials unloading zone. Conversely, the conveyor train 30 is maintained stationary when the conveyor 50 is in motion to load muck at the materials loading zone or unload muck at the materials unloading zone.

In these embodiments, to start the loading process the dual-function loader 19 (or in other implementations a shuttle car, power shovel or other loading device) is moved to the mine face 4 and an empty conveyor train 30 is positioned at the end of the track 20. The dual-function loader 19 is positioned with its discharge conveyor 19b above and overlapping the conveyor train conveyor 50, and the conveyor belt 52 on the conveyor train 30 is activated. In the case of the dual-function loader 19 the conveyor train loading operation can be substantially continuous. If a shuttle car is used instead of a dual-function loader 19, the shuttle car transfers muck 2 to the end of the conveyor 50 at a rate that ideally fills the conveyor belt 52 but does not overload it as the belt moves toward the unloading end 58 of the train 30, and when the shuttle car is empty the conveyor 50 on the conveyor train 30 stops and waits for another load from the shuttle car.

In the preferred embodiment, the conveyor train 30 is fully loaded when the first load of muck 2 loaded onto the conveyor belt 52 reaches the unloading end 56 of the conveyor 50 (furthest from the mine face 4). The conveyor belt 52 is then stopped and the conveyor train 30 departs to the materials unloading zone. The materials unloading zone may be at the end of the track 20, sometimes with a dump wall (not shown) over which the unloading end 58 of the conveyor 50 can discharge its payload. For example, the conveyor train 30 pulls up to the dump wall and stops with the pulley 54 of the conveyor belt 52, which projects beyond the train segments 32, projecting over the dump wall. The conveyor 50 is then started and the load on the conveyor belt 52 is discharged over the dump wall. When the conveyor belt 52 is empty, the conveyor 50 is deactivated and the conveyor train 30 returns to the materials loading zone (in the case of the dual-track embodiment, after switching onto the in-bound track 20 or 24).

In some embodiments the conveyor train 30 may not dump at a permanent materials unloading zone. There are some instances where it is advantageous to dump at a temporary materials unloading zone, for example when there is a need to fill up a stope that has been mined out during the production process. An empty stope is a good place to dispose of waste rock created during the development process. In this case the loaded conveyor train 30 could park at the distal end of the track (furthest from the mine face 4) for the production complex and discharge its load into a shuttle car (or other transport vehicle) which would then drive to and discharge the load into the empty stope.

In the embodiment of the conveyor train 30 illustrated in FIGS. 6-12, the conveyor 50 may be a conventional belt conveyor with a head pulley 55, a tail pulley 54 and a continuous loop of belt 52 surrounding the pulleys 54, 55, with troughing idlers to support the belt on top and return rollers underneath. In another embodiment (not shown), the conveyor may be designed as a piece of conveyor belting that shuttles back and forth between a head reel and a tail reel. This would eliminate the need for both a continuous loop of belt and a separate system to support the belt on the return path. In this embodiment, prior to loading the belting would be wound onto the tail reel. At the start of loading, cables that are attached to the head reel and the leading edge of the belt would pull the belt off the tail reel as loading progresses. Between the head reel and tail reel the belt would be supported in standard troughing idlers. As the belt advances the cables are wound onto a recess in the head reel. When the leading edge of the belt gets to the head reel the train is fully loaded and departs for the dump point. At the dump point the belt is wound onto the head reel and discharges its load over the head reel in the process. Cables that are attached to the other end of the belt and wound into a recess in the tail reel play out as the belt advances. When the belt is completely unloaded the tail reel pulls the belt back and winds it up. The train then returns to the loading point to repeat the cycle.

As described above, the conveyor train may be loaded from an intermediate conveyor (e.g. a shuttle car or other transport vehicle) carrying the broken rock/ore load from the dual-function loader. However, depending on the particular characteristics (e.g., height, reach of the conveyor, etc.) of the intermediate conveyor, it may be difficult for the intermediate conveyor to convey the load over the tail reel of the conveyor train. Thus, in some embodiments a second intermediate conveyor may be positioned at the rail head. The intermediate conveyor or shuttle car discharges the broken rock/ore onto a second intermediate conveyor which lifts the load at an incline to get above the tail reel of the conveyor train to the loading point. In another embodiment, a “storage bin” may also be added to the front end of the second intermediate conveyor to allow rapid unloading of the shuttle car so that the shuttle car can get back to the dual-function loader for the next load. The second intermediate conveyor system may be rubber-tired or track-mounted, and in dual-track embodiments may also be configured to load a conveyor train operating on either or both of the dual tracks.

As noted above the dual-track rail system described herein is further designed to carry rubber-wheeled and/or crawler-mounted equipment on low-bed flat cars (not shown). For example, in the embodiment of FIG. 13 a flatcar may be operated on the standard gauge track comprising rails 22, 26. In further embodiments the single track 20 may be centred in the passageway 12, allowing for the transport of personnel, equipment and materials through a very small drift for additional cost savings.

The rails 22, 26 are shown supported on a series of conventional rail ties 27. Alternatively, in the embodiment illustrated in FIG. 13 all five rails 22, 26 may be supported on a series of elongated pre-manufactured rail ties (not shown), whereby each tie can be designed to support all four rails 22 of the dual-track narrow gauge system and the fifth rail 26 which allows for standard gauge transport. These ties may have pre-installed clips to ensure that the rails are properly (e.g. evenly) spaced apart. The “tie” or rail support system can take advantage of the environment of the underground mine, in which bedrock is always close by. Accordingly, the tie may have two pins protruding from the bottom configured to fit into pre-drilled holes in the floor that are located to position the rails in the desired spot in the drift. Horseshoe-shaped (or other) shims may be inserted around the pins, from the high side, where necessary to lift the tie to the appropriate elevation above the floor rock and to maintain a level mounting. Standard ballast can then be utilized to support the rest of the tie.

In accordance with preferred embodiments of the invention the conveyor train 30 is designed to be end-loaded as opposed to side-loaded, thereby allowing for smaller passageways 12 which increases efficiencies and significantly lowers capital investment and operating costs.

The drive system for the conveyor train 30 may be electric, for example powered via a pantograph or other current collectors (not shown). In the event of downhill transport, the system may be fitted with regeneration equipment to capture the braking energy as electricity that is fed back into the grid. Also, a rail-based system is easily automated because of the absence of the need to steer. Radio frequency tagging equipment may be used to inform personnel of the exact position of a train, to enable switch-changing onto alternative tracks and to position trains for loading and unloading.

In the preferred embodiments the conveyor train 30 is end-loaded at the mine face 4. As muck is placed onto the conveyor belt 52, the belt 52 is advanced along the conveyor train 32 to make room for more ore at the loading end 56. When the ore on the belt reaches the unloading end 58 of the train 30 the loading stops. The conveyor train 30 then departs for the materials unloading zone with the muck loaded on the belt 52.

On the conveyor train 30 the conveyor drive roller 54 at the unloading end 58 may extend out in front of the conveyor train 30 as shown in FIG. 11. At the materials unloading zone outside the mine (not shown) the conveyor drive roller 54 may thus be positioned over the dump point and the conveyor 50 may be restarted (in the same direction as when loaded) to discharge the load of muck. In the dual-track system of FIG. 13 the conveyor train 30 may then switch to the inbound track and move back to the materials loading zone at the mine face 4. Multiple conveyor trains 30 can thus operate simultaneously to allow continuous ore and waste removal at the mine face 4. Switching tracks may be effected by sliding out one piece of track 20 and sliding in an alternate piece of track 20 to direct the conveyor train 30 onto desired track.

In an underground hard rock mine 10 there are multiple activities that can produce broken rock which needs to be removed from the mine, including development and production. Development includes creating the passageways 12 (drifts and ramps) that provide access to anything that needs to be accessed within a mine. FIG. 1 illustrates an example of development implemented within a mine so that workers and machines are able to access the ore. Development typically also includes constructing a ventilation system (not shown) to provide fresh air to portions of the mine where fresh air is needed and to remove stale and polluted air for worker safety.

Production is another activity that produces broken rock. This includes extracting the ore through openings called “stopes” which are excavated in steps or layers. Bulk mining stopes 200 tend to be large vertical or steeply-inclined blocks of ore. The ore can be blasted and will fall to the bottom of the stope, where it is collected by the material handling equipment. Selective mining techniques may be utilized when bulk stopes are not practical, for example, because the ore is vertical and narrow or flat lying and thin. If the ore is narrow then bulk mining tends to dilute the ore by including too much waste rock. If the ore is flat lying then there is generally not enough height to make bulk mining work. Whether the ore is narrow or flat lying and thin, selective mining techniques are similar to development techniques.

From a material handling perspective one of the differences between development and production is that in development the process tends to move forward (e.g., into another area of the mine) at a greater speed than the process of production. For example, development may move forward by four meters per day, and the drift infrastructure needs to be installed in the drift as it advances. The drift infrastructure may include, for example, ground support, ventilation, electrics, rail infrastructure, and the like. On the other hand, in production there are typically few or no construction activities going on at the same time as blasted rock is removed. As such, the production activities tend to happen in the same area for longer periods of time and higher volumes of blasted rock need to be removed on a daily basis.

Regardless of whether it is during development or production, the end result is a pile of blasted rock (muck 2) that needs to be collected and transported to the ground above the mine 10. Many of the development processes described herein occur in a similar manner during production, and it will be understood that the descriptions herein of various development processes also apply to similar processes that occur during production.

The complexities of development arise because during the development process the mining entity is simultaneously constructing the infrastructure of the mine and moving large volumes of blasted rock through the construction project. The ability to simultaneously construct in a small space and move rock through the same small space is one of the keys to being able to advance the drifts quickly and thereby obtain a faster return on capital.

Drilling in the system for underground hard rock mining may be carried out in any conventional manner known to those skilled in the art. For example, depending on the particular characteristics of the mine, drilling at the “face” may be performed using conventional drilling equipment. A series of drill holes may be made into the face during the drilling of the development process by, for example, a single boom jumbo drill and/or two boom jumbo drill (not shown), in conventional fashion. The drill holes serve as receptacles into which explosives may be loaded. Once holes have been drilled into the face at the end of a drift, the development process proceeds by loading the drilled holes with explosives to break the rock during the steps of loading explosives and blasting, as in the example development process shown in FIG. 5. The loading of the explosives may be carried out in any conventional manner known in the art, for example using explosives loading equipment (e.g. an “ANFO Loader”, not shown). The explosives loader loads explosives into the drill holes in the face of the drift so that the rock/ore comprising the face can be blasted and broken apart. Because the system and method of the present invention allow for significantly smaller drifts to be created for underground hard rock mining, the loading of explosives may be performed using equipment that is more compact and less complex, for example a manually movable explosives loader cart (not shown).

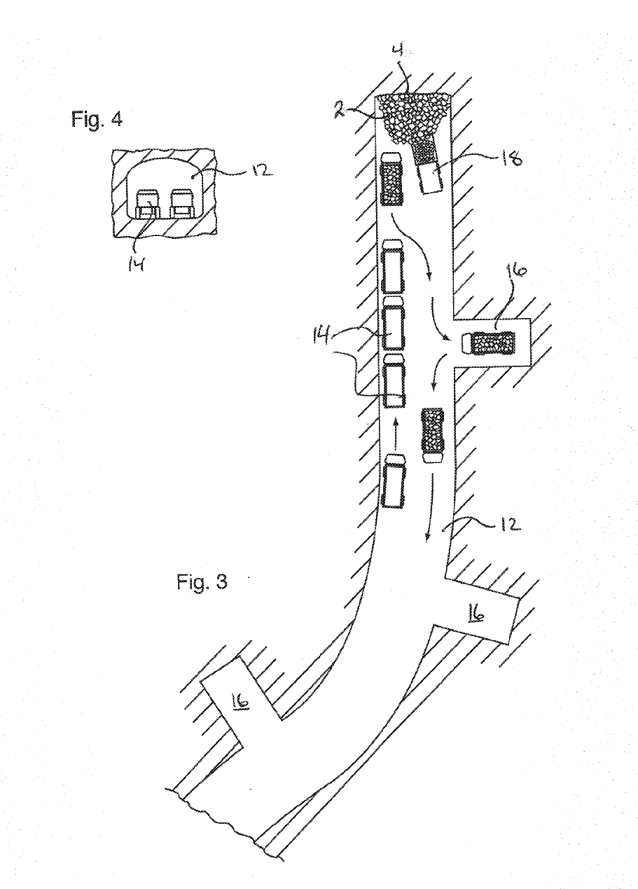

After the blasting step, the development process continues by removing the broken rock/ore resulting from the blast (muck 2). In conventional underground hard rock mining operations, the equipment used for removing broken rock/ore is a “front end loader” called an LHD (load/haul/dump) or “scooptram” 18, which then loads a truck 14 for long distance haulage of the muck 2, as shown in FIG. 3. The system and method of the invention is particularly advantageous during this stage. The use of one or more end-loading conveyor trains 30 in the removal of broken rock/ore significantly increases the speed and efficiency of this part of the underground mining process, especially in the case in the dual-track rail system of the present invention which allows for multiple conveyor trains to be in service simultaneously, permitting continuous removal of muck 2 from the mine face 4 within the drift, thereby significantly speeding up the muck removal process.

In some embodiments a mucking loader or “dual-function loader” 19, shown in FIG. 6 may be used to pick up broken rock/ore from the floor of the mine 10 in front of the mine face 4. The dual-function loader has a loading end with a shovel 19a for collecting muck 2 and an internal conveyor 19b that moves collected muck 2 towards the back-end of the dual-function loader 19, thereby freeing-up space at the loading-end of the dual-function loader 19 for more muck 2 to be collected. In the system and method for underground hard rock mining described herein, a major advantage of using a dual-function loader over a scooptram 18—in which the muck 2 is in a bucket at the front of the machine and in order to transfer the muck 2 to the next machine the LHD equipment must turn around so that the bucket is in position to dump its load—is that a dual-function loader 19 quickly deposits broken rock onto its internal conveyor which discharges the muck 2 off the back end of the machine to transfer it to another piece of equipment, without changing its position or orientation. This also obviates the need for conventional LHD equipment such as a scooptram 18 to turn around, which avoids having to create wider drifts, or expensive excavations into the wall of the mine 10 to create turnaround bays 16 (shown in FIG. 1) that provide a turning opportunity for such equipment.

The dual-function loader 19 is mobile and can thus be positioned between the mine face 4 and the loading end 56 of the conveyor train 30. Once the muck is deposited on the dual-function loader 19 conveyor 19b, the conveyor train 30 can be end-loaded, either directly or via an intermediate portable conveyor known in the coal mining industry as a “shuttle car” (not shown) that moves the muck 2 to the conveyor train 30. Employing an intermediate conveyor between the dual-function loader 19 and the conveyor train 30 could be advantageous in situations where a decision is taken to not install blasting mats to protect the rail infrastructure and hence the rail system must be maintained well away from the mine face 4 to avoid damage from flying rock produced by blasting operations. It will be understood that various other types of conveyors may be used as an intermediate conveyor between the dual-function loader 19 and the conveyor train conveyor 50 in addition to or instead of a shuttle car. However, an intermediate conveyor between the dual-function loader 19 and the conveyor train 30 is not required where the potential for damage to the conveyor train has been eliminated or minimized (e.g., blasting operations are complete or have the rail system has been protected from fly-rock), and in this situation muck 2 may be transferred from the internal conveyor 19b of the dual-function loader 19 directly onto the conveyor of the conveyor train 30.

In either case, end-loading the conveyor train 30 according to the invention rather than side-loading avoids the need for the cross-sectional area of the drift to be wide enough to accommodate the loading apparatus (e.g. a shuttle car) beside the conveyor train 30 in order to progressively dump ore along the conveyor train 30. The conveyor 50 of the conveyor train 30 allows the conveyor train to be end-loaded until full of muck 2 and then deactivated, essentially converting the conveyor train 30 to a cargo train carrying muck 2 on all of its segments 32.

According to the invention, a conveyor train 30 utilized in the dual-track rail system described herein would preferably operate on rails 20 as shown in FIGS. 13 and 14. In the dual-track embodiment there can be multiple conveyor trains 30 operating simultaneously within the mine 10. For example, while one conveyor train 30 is being loaded with muck 2 for transport to the materials unloading zone, there could be another conveyor train 30 waiting on the other track 20 to be loaded once the first conveyor train 30 on the other track is fully loaded.

The dual-track rail system may employ two pass ground support. One pass would support freshly excavated ground so that it is safe to go back in the drift and drill again. The second pass would be for long-term support that would provide a safe operating environment for the life of the drift. For example, in the second pass could be performed from a “bolting platform” that is narrow and operates on one track while the other track is being utilized for muck 2 removal. This differs from conventional approaches, which utilize “short and wide” trucks (not shown) which do not leave room in the drift to conduct side-by-side operations. Hence, while in conventional systems processes occur in series and little takes place in parallel, parallel operations are readily employed in many embodiments of the system of the invention.

As noted above, personnel may be transported through the mine on ground mounted rail using conventional road vehicles equipped with a ‘hi-rail’ attachment designed to enable the vehicle to operate on a rail system for the invention, which may be of a non-standard gauge. The narrow-gauge track 20 shown utilizes rails 22 for equipment in the system of the invention. Adding a further outside rail 26, positioned for example 4′ 8½″ from the other rail 22 to create a standard gauge option as in track 24 shown in FIG. 13, allows a standard rail car to travel on the same rails implemented for the system an method of the invention. It will be appreciated that in this embodiment when the standard gauge option is in use, the dual-track system cannot be utilized at the same time on the same section of track.

One advantage of the personnel transport system described above is that personnel are not limited to the range of the tracks 20 either on surface or underground. For example, personnel may drive on conventional roads (with the hi-rail adapter kit in the disengaged position) until they get to the rail head where they can then take their vehicles (with the adapter kit in the engaged position) and continue underground using the rails 22, 26. Similarly, when personnel arrive at the end of the rail system to the rubber-tired area of a drift (or ramp), they can take their vehicles off the rails 22, 26 and drive (with the adapter kit in the disengaged position) directly to their destination. For example, if a mechanic is travelling to repair a disabled machine within the mine 10, the mechanic's tools and equipment may be driven directly to where they are needed.

Bringing consumable supplies into a mine and removing waste from consumables is a major consumer of labour and cost in a mining operation. The dual-track rail system embodiments of the present invention can be used to automate the supplies handling process for a significant reduction in those costs. The ability to automate the transit portion of supplies handling is afforded by the use of a vehicle on rails (for example in the dual-track rail system embodiment) without the need to steer the vehicle. However, a second requirement for automating the supplies handling process is automating the loading and unloading of the supplies. In accordance with some embodiments of the invention, automating the process of loading and unloading supplies may be achieved by containerizing the supplies and using remote controlled loading equipment (not shown), optionally video monitored. The majority of supplies used in a mine are repetitive and predictable. Standard containers used on surface railroads may be larger than desirable for easy transport through smaller drifts/ramps. Accordingly, containers used underground for specific supplies may be standardized at a smaller size and designed for efficient loading and unloading of the supplies. Thus, containerized supplies may be transported through the mine in a manner similar to conventional surface-based cargo trains, but with smaller (and perhaps fewer) containers. Loading and unloading containers within the underground mine may be handled using a mobile lift truck with a container attachment, which may be operated via video remote control. In another embodiment, a fixed overhead crane may be used in place of the mobile lift truck to load and unload containers from the supplies train.

In the supplies handling system described herein, supply bays (not shown) similar to conventional turnaround bays 16, excavated into the walls of the mine 10, may be designed to service rubber-tired areas and/or rail-based areas. The supply bay may include an area for supplies storage and an area for fuel and oil storage. Additionally, the supply bay may include an access area for rubber-tired vehicles to enable rubber-tired vehicles to access the other areas of the supply bay. In some embodiments the supply bay may be for supplies storage in a production area serviced by rubber-tired vehicles. Supplies may be delivered by train (e.g. using the standard-gauge rails 22, 26) and picked-up by the crew and other personnel using rubber-tired vehicles. In other embodiments, supply bays for “rail only” areas of the mine may be similar to the supply bays for rubber-tired areas. However, supply bays for rail-based areas would not need an access area for rubber-tired vehicles at the back end of the supply bay. Dedicated supply trains may operate to stock the supply bays. Materials may be loaded from the supply bay onto rail-based vehicles that are fit for purpose for using the supplies, such as the bolting platform described above.

The automated transport system embodiments for an underground hard rock mine operation described herein are designed to move people, ore and waste rock, and supplies and supplies waste. In preferred embodiments the system of the invention fits into a four meter (4 m) wide by four meter (4 m) high drift and supports excavating the drift at a linear advance rate of up to sixteen meters (16 m) per day, so as to reduce the time between capital deployment and production of revenue. The system is preferably electric powered to reduce overall ventilation requirements and alleviate ventilation restrictions on the number of “batch” material handing vehicles that are in use on the system. With no effective limit on the number of conveyor trains that can be placed on the system, the materials handling system will cease to be the bottleneck of underground mines. This will allow significantly more production, per unit of time, from the same mining assets. Higher volumes from a mining complex means that the required daily production can be obtained from fewer mining complexes, meaning that capital for those “other” complexes can be deferred.

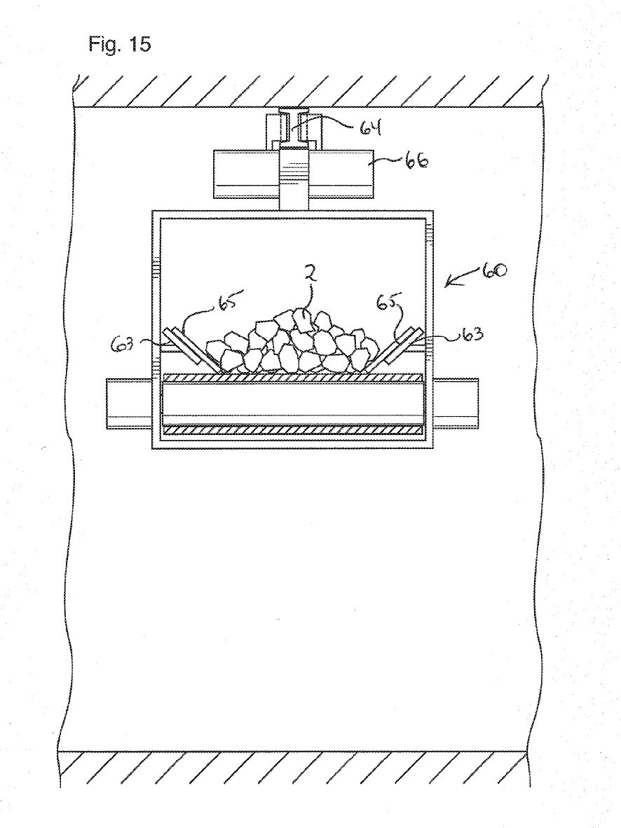

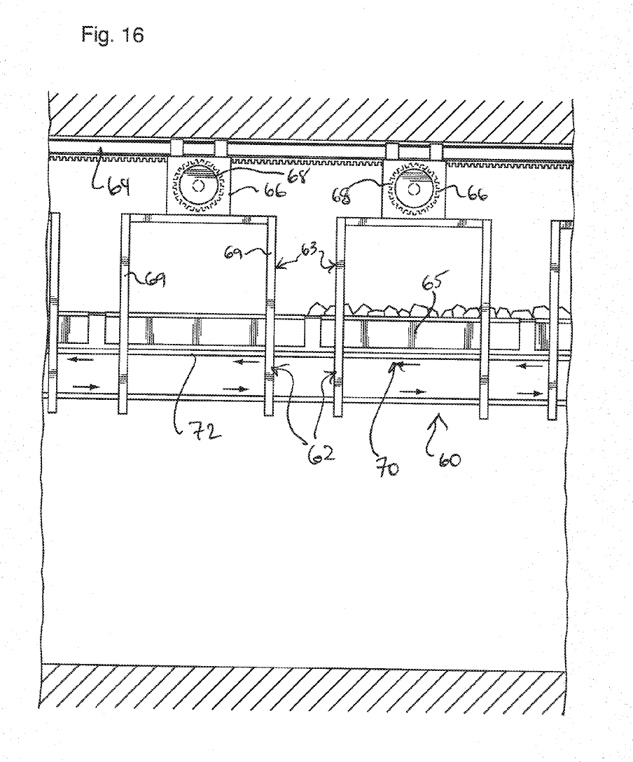

In a further embodiment of the conveyor train, illustrated in FIGS. 15 and 16, the conveyor train 60 is essentially a monorail designed in the same manner as the track-mounted embodiment of FIGS. 6-12 (i.e. constructed and operated in the manner described in U.S. Pat. No. 6,651,804), but in which the connected segments 62 are supported by a rail affixed to the back (i.e. ceiling) of the drift. The 64 rail (or a secondary rail, not shown) suspending the conveyor train 60 also serves as a rack in the embodiment illustrated, and a drive motor 66 affixed to an appropriate number of segments 62 is engaged to the rack 64 via a gear 68 to drive the conveyor train 60. In the preferred embodiment each segment 62 of the conveyor train is supported by a frame 63 having its own motor, dividing the power necessary to move the loaded conveyor train 60 up a drift amongst a series of relatively small drive motors, which may for example be electrically powered.

As in the track-mounted embodiment of FIGS. 6-12, each segment frame 63 comprises a pair of vertical supports 69 on each side of the frame 63. Each pair of vertical supports 69 in turn supports a side panel 65 at an angle converging toward the conveyor 70, via side supports 63, so as to provide a ‘trough’ shape in cross-section, as best seen in FIG. 15, with the conveyor belt 72 as the floor of the ‘trough’. In this case the frame 63 of each segment 62 is suspended on the rail 64 by bearings 69 (seen in FIG. 15).

In this embodiment the conveyor train 60 may be suspended at a distance from the floor of the drift comparable to the height of the track-mounted embodiment of the conveyor train 30, however when loading it may not be possible to overlap the dual-function loader discharge conveyor with the conveyor train conveyor 70 because the segment frames 33 which suspend the conveyor 70 obstruct the area above the conveyor belt 72. This embodiment of the conveyor train 60 may be provided with an extension (not shown) at the loading end over which the dual-function loader conveyor 19b can overlap, or alternatively can be end-loaded by a mobile infeed conveyor, front end loader or via any other suitable means.

The design and operation of this embodiment is otherwise the same as the track-mounted embodiment of FIGS. 6 to 12. However, in these embodiments there is no need for hi rail attachments for rubber-tired equipment. When the conveyor train 60 is not in the drift, the rubber-tired equipment can drive along the floor of the drift well below the monorail that is attached to the back (ceiling) of the drift.

The system of the invention is preferably able to move rubber tired or crawler mounted equipment through the same 4 m wide by 4 m high drift described above. In preferred embodiments the system is capable of moving a 50 tonne payload up a 15% ramp, and to navigate corners having a 50 meter radius while in transit.

Various embodiments of the present invention having been thus described in detail by way of example, it will be apparent to those skilled in the art that variations and modifications may be made without departing from the invention. The invention includes all such variations and modifications as fall within the scope of the appended claims.

1-10. (canceled)

11. A method of extracting materials from an underground mine comprising at least one drift comprising a floor, a back and walls, comprising the steps of:
a. suspending at least one mobile conveyor from the back of a drift, the mobile conveyor being movable between a materials loading zone and a materials unloading zone and being suspended from at least one rail disposed above a height of wheeled equipment when positioned on the floor of the drift,
b. positioning the at least one mobile conveyor in a the materials loading zone;
b. loading a conveyor extending along a length of the at least one mobile conveyor by, concurrently or intermittently,
b.1 loading materials onto an upstream end of the mobile conveyor, and
b.2 activating the mobile conveyor's conveyor to move the materials downstream along the mobile conveyor;
c. driving the at least one mobile conveyor to the materials unloading zone; and
d. unloading the mobile conveyor.

12. The method of claim 11 comprising two mobile conveyors.

13. The method of claim 12 wherein in step b. both of the mobile conveyors are loaded concurrently.

14. The method of claim 12 wherein in step b. both of the mobile conveyors are loaded alternately.

15. The method of claim 12 comprising the step, at any time, of removing both of the mobile conveyors from the drift and driving a wheeled vehicle into the drift to move equipment, supplies or personnel, or any combination thereof, into the mine.

16. A system for extracting materials from an underground mine comprising at least one drift comprising a floor, a back and walls, comprising
at least one mobile conveyor for moving the materials between a materials loading zone and a materials unloading zone, the mobile conveyor being suspended from at least one rail affixed to the back of the drift and comprising a conveyor, the at least one rail being disposed above a height of wheeled equipment when positioned on the floor of the drift, and
a loading apparatus for loading materials onto an upstream end of the mobile conveyor's conveyor when the mobile conveyor is stationary,
whereby when the mobile conveyor's conveyor is loaded the mobile conveyor can be repositioned to a materials unloading zone and the conveyor can be activated at the materials unloading zone to unload the mobile conveyor.

17. The system of claim 16 comprising two mobile conveyors each suspended from at least one rail.

18. The system of claim 17 wherein in the mobile conveyors each comprise a plurality of frame segments, each frame segment being suspended from the at least one rail.

19. The system of claim 18 wherein the mobile conveyor segments are each provided with a drive motor.

20. The system of claim 17 further comprising at least one wheeled vehicle for driving into the drift to move equipment, supplies or personnel, or any combination thereof, into the mine when the mobile conveyors are removed from the drift.
